(19) United States
(12) Patent Application Publication
(10) Pub. No.: US 2019/0291670 A1
(43) Pub. Date: Sep. 26, 2019

(54) CROSSMEMBER FOR ARRANGING ON A MOTOR VEHICLE

(71) Applicant: BENTELER AUTOMOBILTECHNIK GMBH, Paderborn (DE)

(72) Inventors: Joern TOELLE, Paderborn (DE); Christian HANDING, Langenberg (DE); Kim-Henning SAUERLAND, Bielefeld (DE)

(21) Appl. No.: 16/351,581

(22) Filed: Mar. 13, 2019

(30) Foreign Application Priority Data
Mar. 20, 2018 (DE) 10 2018 106 526.4

(51) Int. Cl. B60R 19/18; B60R 19/02; B62D 21/02

(52) U.S. Cl. CPC B60R 19/18; B60R 2019/182; B62D 21/02; B60R 19/023

(57) ABSTRACT

The disclosure relates to a crossmember for arranging on a motor vehicle, wherein the crossmember is formed in two parts from a profile, which is open on one side, as seen in cross section, and from a closing panel, each being made of metallic material, and the crossmember and the closing panel are coupled to one another, wherein the closing panel is produced in the form of an extruded light-metal component, wherein an extrusion direction is oriented transversely to the longitudinal extent of the crossmember and, as seen in the longitudinal extent of the crossmember, the closing panel has regions of different wall thicknesses.

The present invention relates to a crossmember for arranging on a motor vehicle according to the features in the preamble of patent Claim 1.

The prior art discloses crossmembers which are arranged at the front or rear of a motor vehicle. These crossmembers are mostly coupled to longitudinal members with crash boxes being incorporated in the process.

In the event of a collision in the longitudinal direction of a motor vehicle, it is desirable to have a crossmember which is as flexurally rigid as possible, so that the force of a colliding obstacle does not penetrate directly into the motor vehicle. In particular, the intention is for the impact force to be distributed over the crash boxes and then introduced into the longitudinal members of the motor vehicle.

Such crossmembers are produced either as a formed sheet-metal part, usually from a steel alloy, or as an extruded component, for example from an aluminum alloy.

As seen in cross section, the crossmembers are often designed in the form of a hollow component. It is also known for crossmembers to be produced, as seen in cross section, such that profiles which are open on one side are closed by a closing panel.

The object of the present invention is to provide a crossmember which has an optimum crash behavior, partially required strength properties and a low component weight.

The aforementioned object is achieved, as far as a crossmember for arranging on a motor vehicle is concerned, according to the features in Claim 1.

Advantageous variants form the subject matter of the dependent claims.

The crossmember for arranging on a motor vehicle is formed in two parts from a cross-sectionally open profile and from a closing panel. The crossmember can also be referred to as a motor-vehicle crossmember or a bumper rail. The profile itself is produced preferably from metallic material and, in particular in the form of a three-dimensional press-formed component, from a steel alloy. However, it is also possible for the profile to be an extruded profile which has additionally been subjected to press forming. The profile is coupled to the closing panel, in particular by thermal joining.

Provision is made according to the invention, then, for the closing panel itself to be produced in the form of an extruded light-metal component, wherein an extrusion direction is oriented transversely to the longitudinal extent of the crossmember itself and, as seen in the longitudinal section of the crossmember, the closing panel has regions of different wall thicknesses. As an alternative, or in addition, the closing panel has at least one hollow chamber. The hollow chamber is simultaneously produced directly by the extrusion of the closing panel. The cross section of the hollow chamber is located, as it were, in the longitudinal section through the crossmember. Once again as an alternative, or in addition, the closing panel has at least one crosspiece projecting from the closing panel. Likewise in just the same way as the aforementioned hollow chamber, the crosspiece is then simultaneously produced in one piece with, and in the same material as, the closing panel by extrusion. The closing panel is thus produced from a light-metal alloy, in particular an aluminum alloy, particularly preferably with a yield strength of 250 MPa to 500 MPa. The same also applies to the profile.

This variant according to the invention is made possible by a tailored extruded blank. This means that the extruded profile is produced first of all with a relatively narrow extruded width. The extruded profile itself has a cross section which can undulate in the form of an omega or pi. In a subsequent processing step, this relatively narrow extruded cross section is widened and/or flattened to form a considerably greater processing width. This processing width can be up to 100 cm or more. Either before or after the flattening and/or widening operation, the extruded profile is cut to length to give individual profile pieces. The cut length corresponds approximately to the subsequent height of the closing panel in the vertical direction of the motor vehicle.

Appropriate choice of an extrusion tool makes it possible to set, along the extrusion cross section itself, wall thicknesses which differ from one another as desired. It is optionally also possible for individual hollow chambers or crosspieces to be formed simultaneously. The closing panel thus has varying and different wall thicknesses in the longitudinal direction.

The thus flattened and/or widened profile piece then forms the closing panel. The latter can also be subjected, if appropriate, to forming operations and is then coupled to the profile. Use can be made here, in particular, of spot welding or a similar thermal joining operation, but also of adhesive bonding.

The profile itself is of top-hat-shaped or C-shaped design in the cross section of the crossmember. The closing panel can then be positioned at the respective ends of limbs or flanges and coupled to the profile to produce the crossmember. The crossmember is thus designed in the form of a hollow profile, as seen in cross section, at least along certain length portions. It is also possible for the closing panel to be arranged in an opening of the profile and then to be welded to inner sides of limbs of the profile.

In an installed position in the motor vehicle, it is possible, for example as far as a front crossmember is concerned, for the closing panel to be oriented toward the rear, as seen in the direction of travel. The profile is thus arranged at the front, as seen in relation to the direction of travel. An inverse arrangement, so that, as far as a front crossmember is concerned, the closing panel is oriented toward the front, as seen in the direction of travel, is likewise possible within the context of the invention.

Resistance spot welding can be the thermal joining operation used to couple the closing panel, in particular where it comes into abutment in a double-layered arrangement, to flanges of the profile, as a result of which the profile is designed here, in particular, in the form of a top-hat profile. However, it is also possible to select C-shaped or U-shaped cross sections for the profile. Use can then be made here, for example, of inert-gas welding or laser welding or remote laser welding. In particular, combinations of steel material and light-metal material are possible. It is also possible here for the joining method used to be rivet welding or spot-weld bonding.

Within the framework of the invention, the closing panel can preferably have wall thicknesses of 2 to 10 mm. The extrusion method makes it possible to realize correspondingly smooth, but also step-like, changes in thickness. The relatively thick wall thicknesses present on the closing panel, but also the thinner wall thicknesses, are therefore located within this range.

The closing panel can also have extensions, in particular in the form of projecting crosspieces or ribs. Following coupling of the closing panel to the profile, the extensions can project into the profile itself. As an alternative, or in addition, it is possible for the extensions to project on that side of the closing panel which is opposite the profile, and therefore, when a front crossmember is in an installed position, to project for example in the rearward direction. It is particularly preferred, however, for the extensions to project, for example, into a hollow chamber of the crossmember. It is thus possible to form stiffening ribs in the crossmember.

As a further preferred variant, at least one hollow chamber is simultaneously extruded on the closing panel and is thus arranged in one piece with, and in the same material as, the closing panel. There are various areas of use here. For example, if installation-space provision is restricted, it is possible for the crash box to be simultaneously produced in one piece with, and in the same material as, the closing panel directly by extrusion of a respective hollow-chamber profile or multi-chamber hollow profile in the region where crash boxes are to be arranged. In particular, in this case, the hollow chambers are then arranged on a closing panel coupled to the profile, and on the rear side of the closing panel.

A further preferred variant makes provision for a chamber, in particular a hollow chamber, to be simultaneously formed in the region of a towing eye which is to be fitted. This means that a mount or fastening for fitting a towing eye is simultaneously formed in the region of the closing panel, in one piece therewith, and in the same material as the same.

A further variant makes provision for at least one hollow chamber, preferably a multi-chamber hollow profile, to be formed on a front side of the closing panel, so that said hollow chamber projects into the profile and therefore, when the profile and closing panel are coupled, is arranged in the crossmember.

Further advantages, features, properties and aspects of the present invention form the subject matter of the following description. Preferred variants are illustrated in the schematic figures, in which:

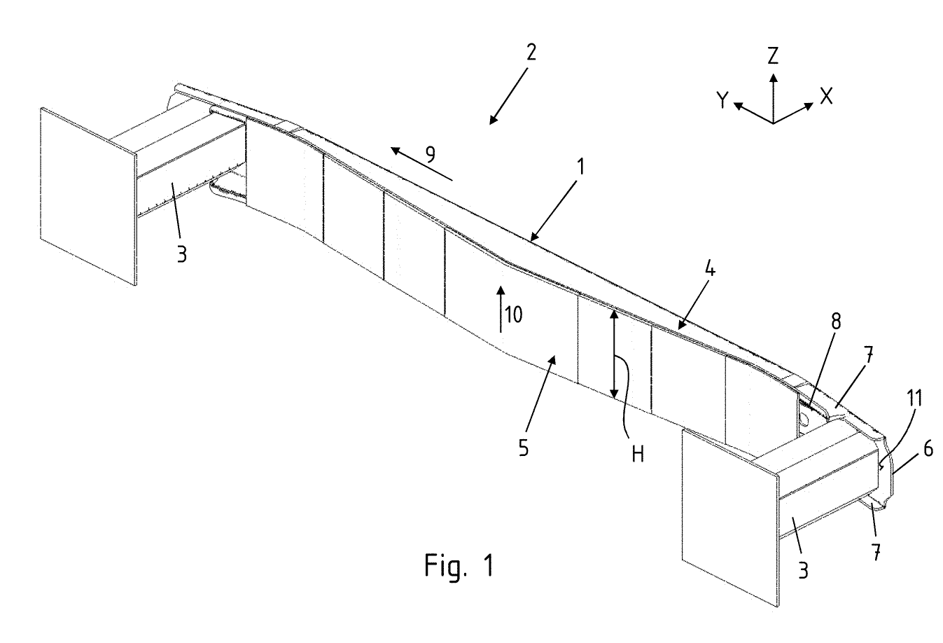

FIG. 1 shows a perspective view from the rear of a crossmember according to the invention,

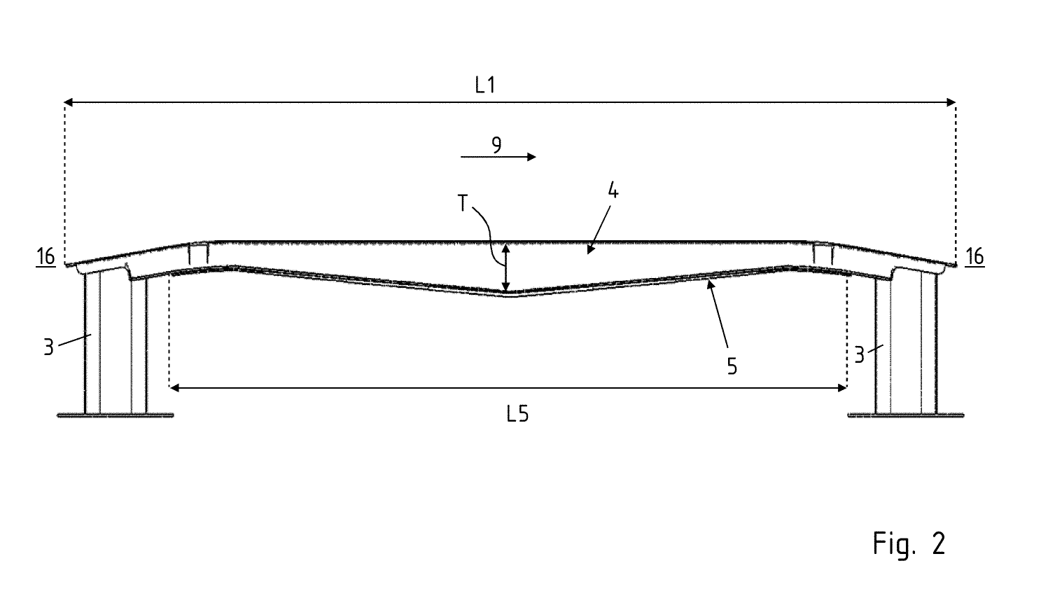

FIG. 2 shows a plan view of the crossmember according to FIG. 1,

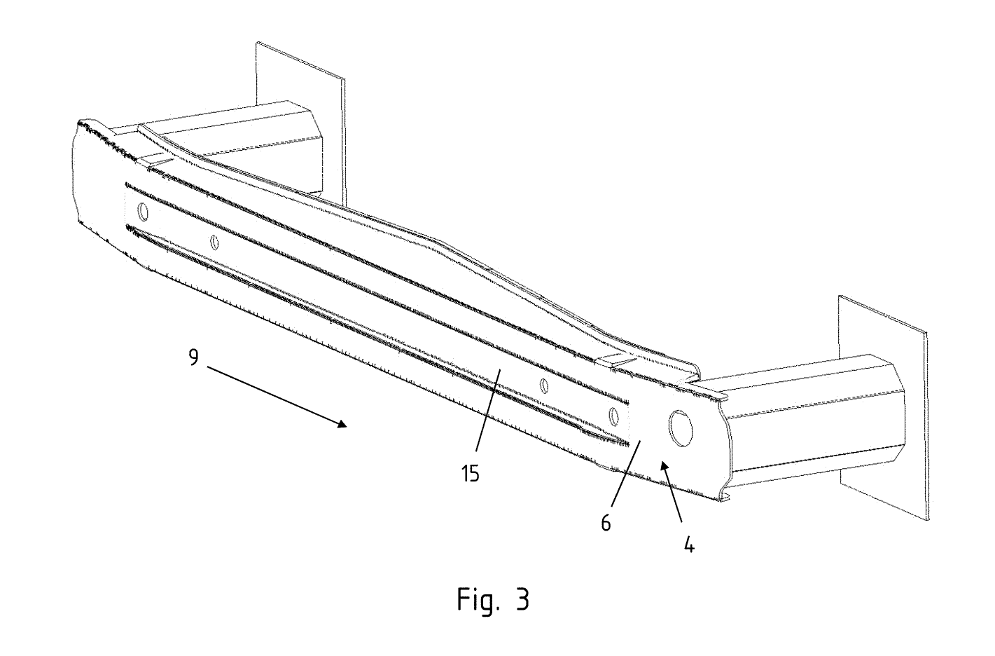

FIG. 3 shows a perspective view from the front of the crossmember,

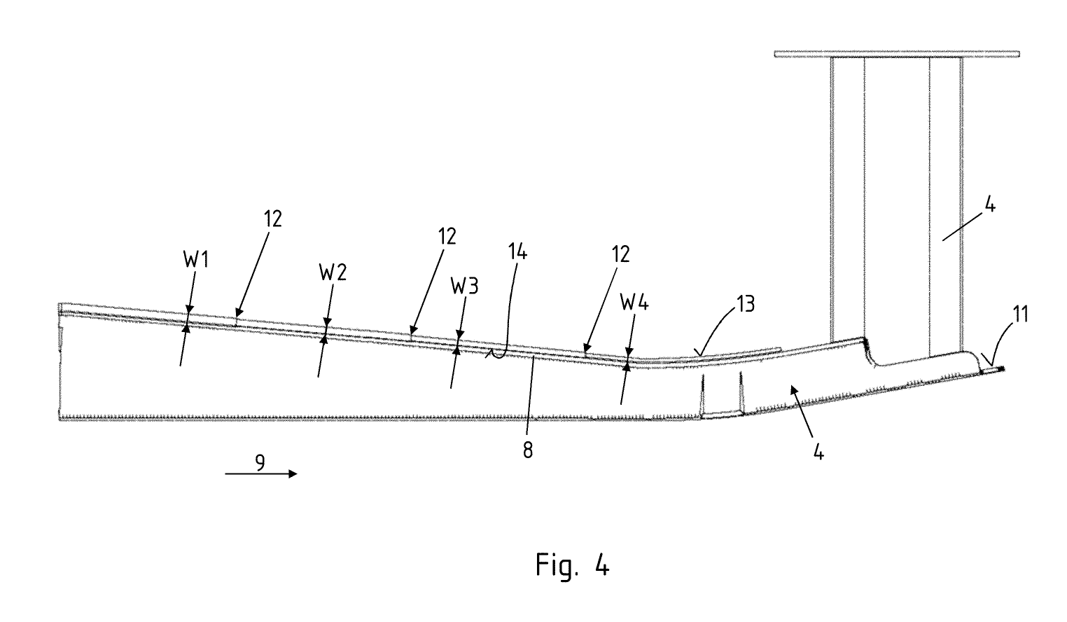

FIG. 4 shows a detail-specific plan view of half the crossmember,

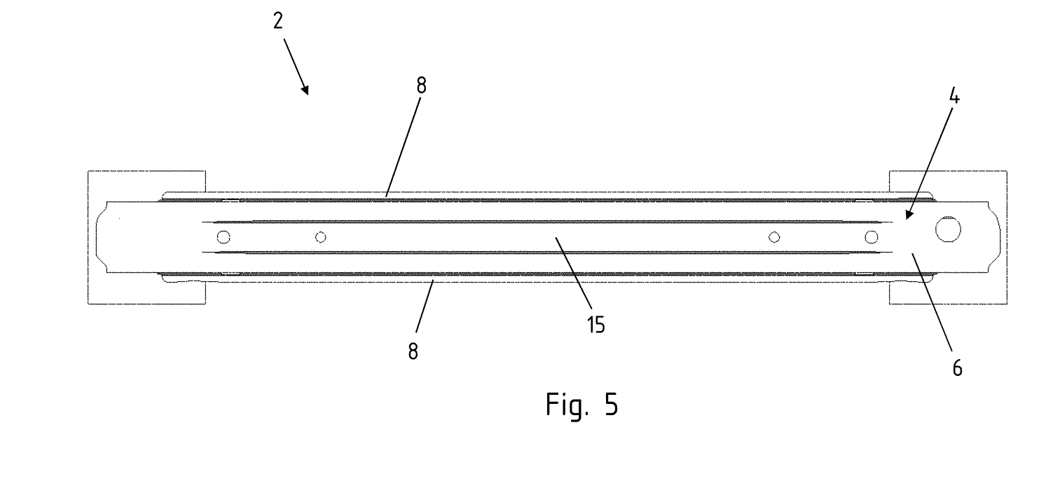

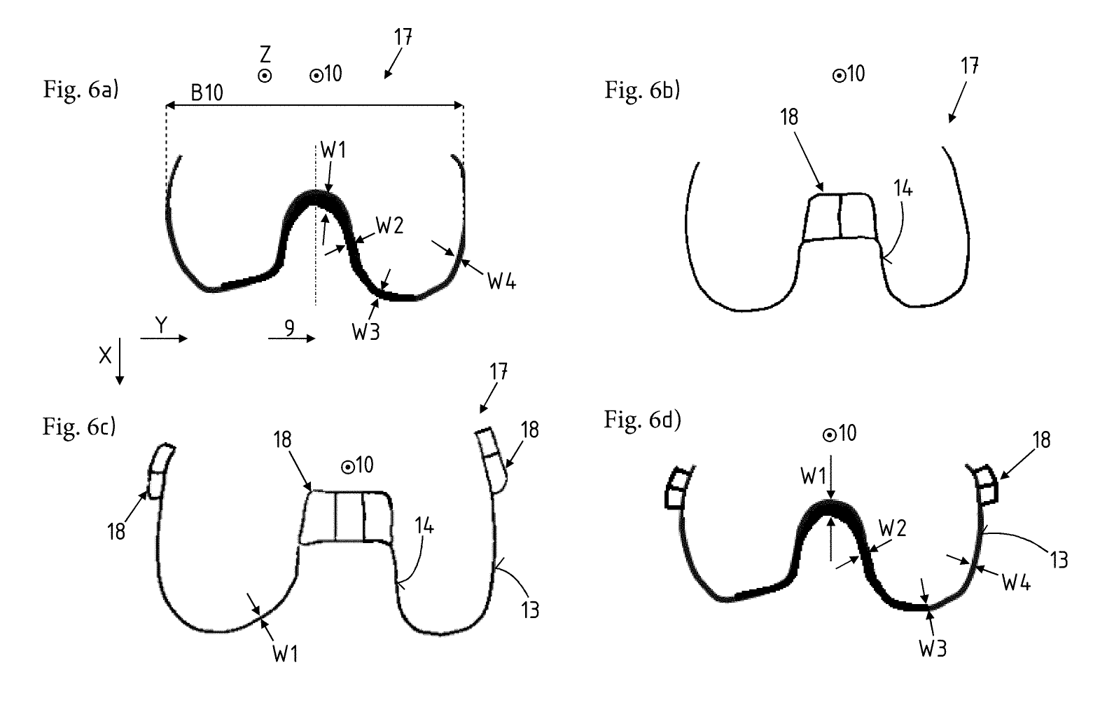

FIG. 5 shows a front view of the crossmember, FIGS. 6a to d show various cross sections of an extruded profile,

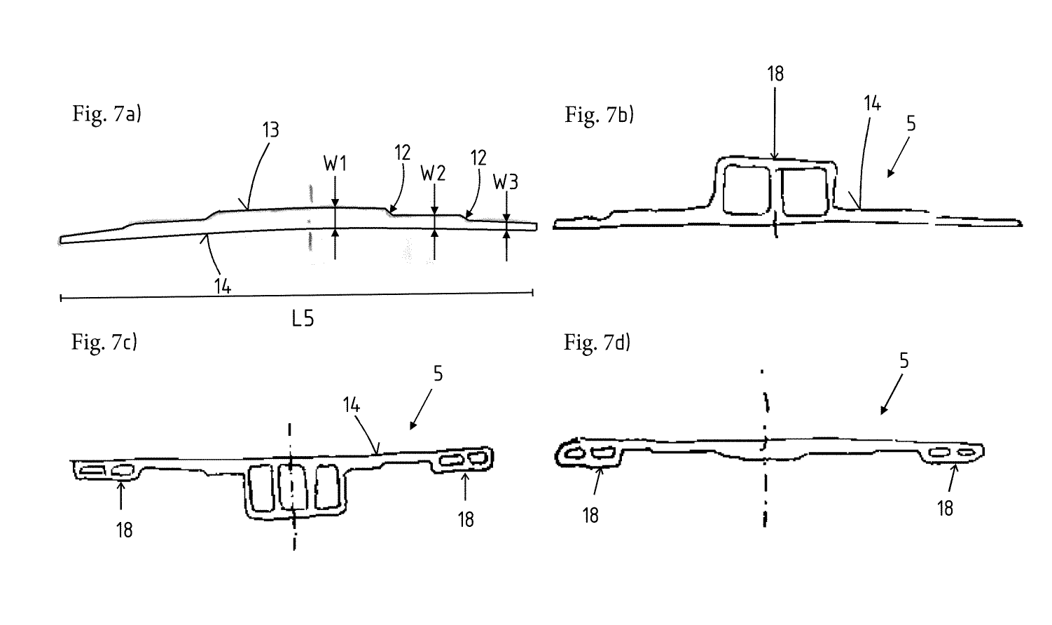

FIGS. 7a to d show the cross sections from FIG. 6 following the widening operation,

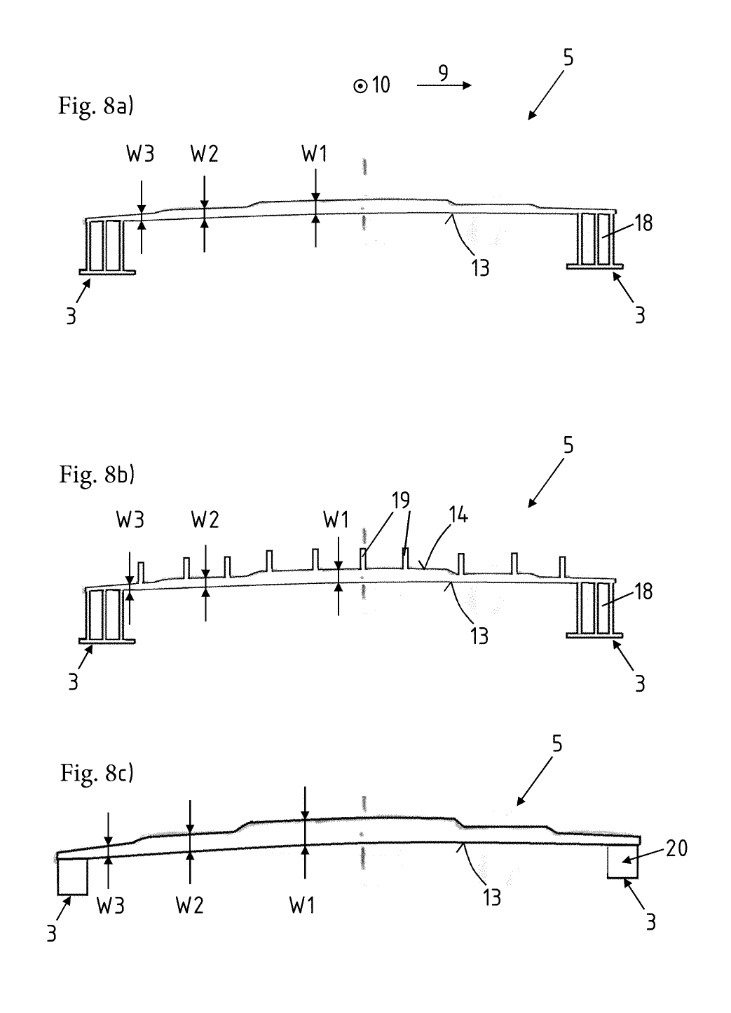

FIGS. 8a to c show a plan view of various closing panels,

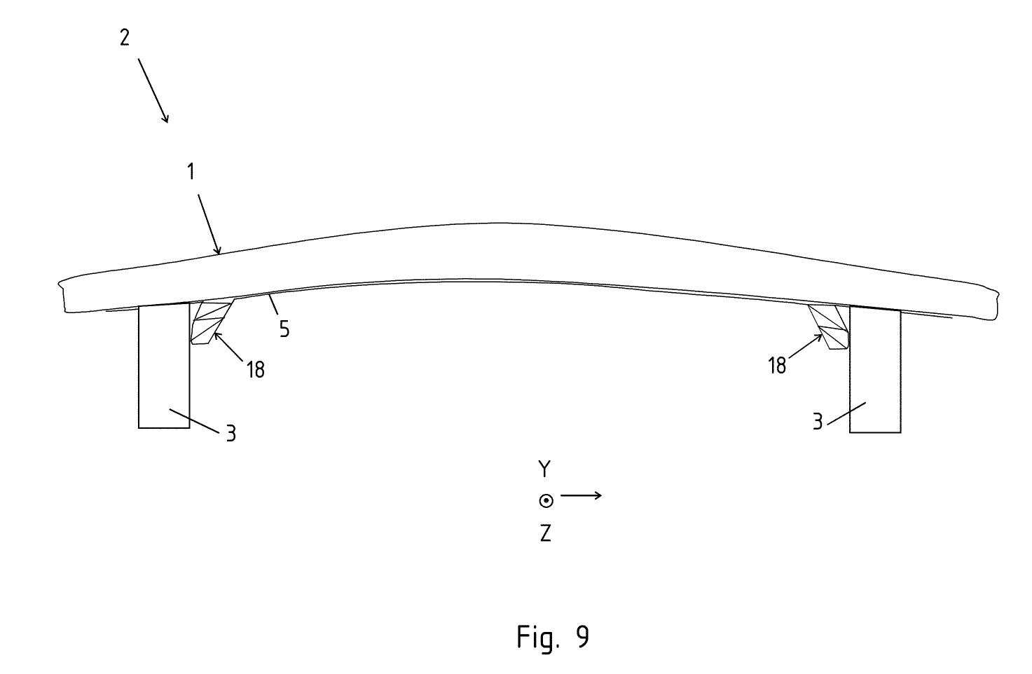

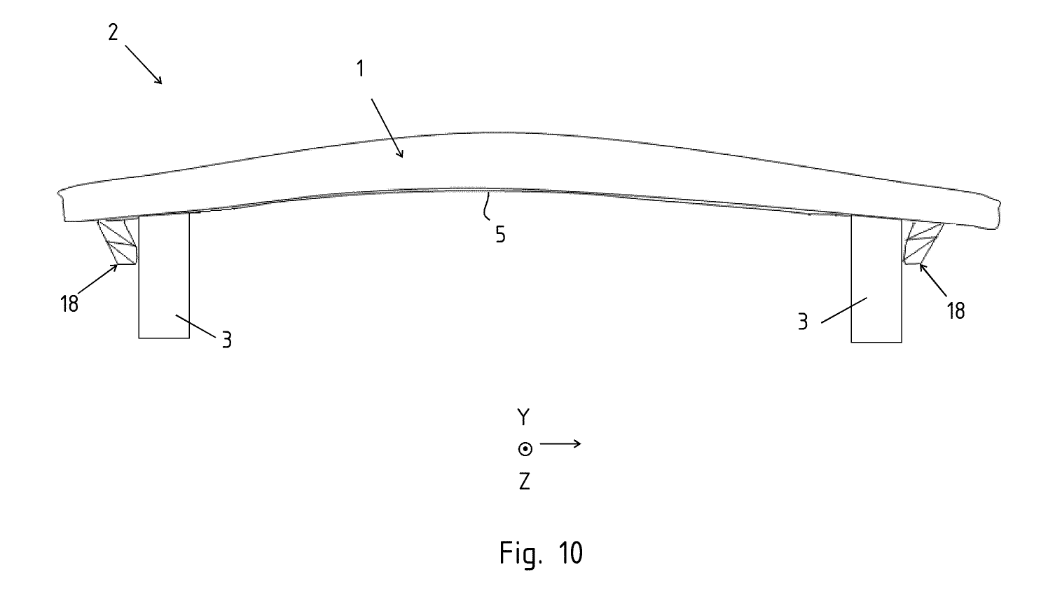

FIGS. 9 and 10 show a plan view of a crossmember arrangement with lateral support on the crash box, and

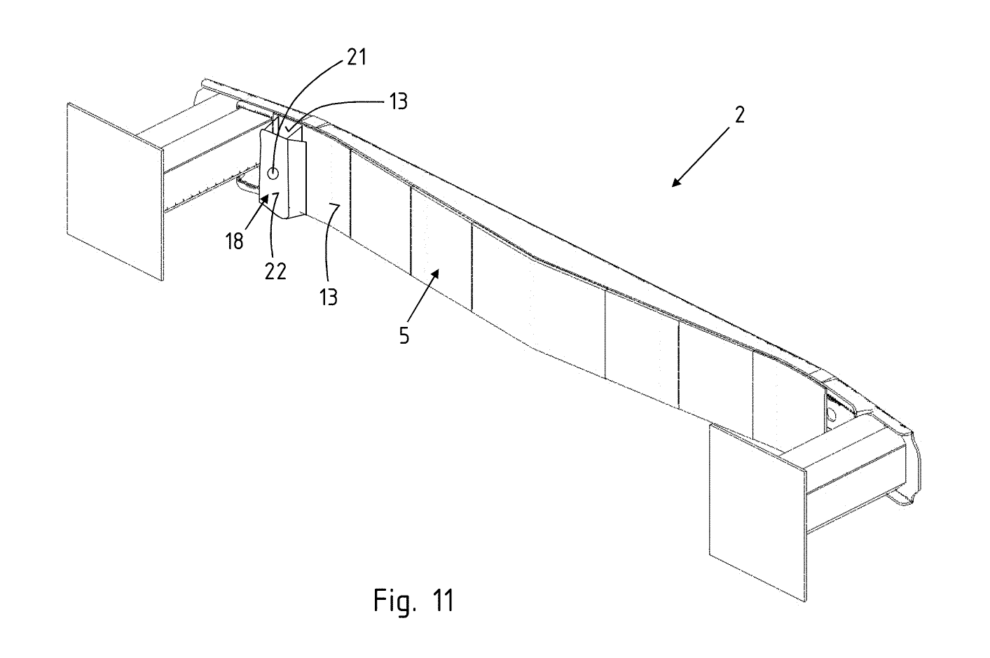

FIG. 11 shows a crossmember arrangement according to the invention with a hollow chamber for accommodating a welding bush for a towing eye.

FIGS. 1 to 5 show a crossmember 1 according to the invention, here in the form of a crossmember arrangement 2, having additional crash boxes 3, which are fastened on the crossmember 1 in respective end regions of the same. The crossmember 1 itself is formed from a profile 4 and from a closing panel 5 coupled to the profile 4.

The profile 4 itself is of top-hat-shaped design in cross section, having a front wall 6, limbs 7, which project in the rearward direction from the wall 6, and flanges 8, which in turn project from the limbs 7. In this variant, the closing panel 5 is coupled to the flanges 8.

The longitudinal extent 9 of the crossmember 1 itself is oriented in the transverse direction of the motor vehicle. As seen in the transverse direction of the motor vehicle or in the longitudinal extent 9, the closing panel 5 has regions of different wall thicknesses W1, W2, W3, W4. The closing panel 5 itself is produced in the form of an extruded component. The extrusion direction 10 of the closing panel 5 here is oriented transversely to the longitudinal extent 9 as can be seen in FIG. 2. It is also illustrated here that the closing panel 5 extends, by way of a length L5, only over part of the length L1 of the profile 4 or of the crossmember 1. It is possible for the crash boxes 3 to project into the crossmember 1 and to come into abutment here against a rear side 11 of the wall 6 or to be coupled to the crossmember 1 in some other way.

It is thus possible for different wall thicknesses W1, W2, W3, W4 to be formed on the closing panel 5 (cf. FIG. 4), wherein four different wall thicknesses W1, W2, W3, W4 are illustrated here. The wall thickness W1 is greater than the wall thickness W2. The wall thickness W2 is greater than the wall thickness W3 and the wall thickness W4 is, in turn, smaller than the wall thickness W3. Transition regions are formed between the different wall thicknesses W1, W2, W3, W4. The transition 12 can be, for example, step-like. However, it is also possible for the transition 12 to be in the form of a smooth transition 12. For example, this can be progressively linear or degressive. In particular, the transition 12 illustrated here is formed on a rear side 13 of the closing panel 5, so that a front side 14 of the closing panel 5 butts against the flange 8 of the profile 4. The closing panel 5 itself can follow a correspondingly curved or three-dimensional course. The closing panel 5 itself has a height H, which is oriented in the vertical direction Z of the motor vehicle. It is possible for the height H to be constant or variable, and therefore to increase or decrease, as seen in the longitudinal extent 9.

FIG. 3 shows a further variant, albeit one which need not be provided as a rule. In this case, a groove 15 has been introduced in the profile 4 or in the wall 6 of the profile 4. The groove 15 likewise extends along certain length portions of the longitudinal extent 9 of the profile 4. The groove 15 can likewise have an advantageous effect on the stiffness characteristics.

It can likewise be seen in FIG. 2 that the depth T of the profile 4, and in this case specifically of the limbs 7 of the profile 4, varies along the longitudinal extent 9. In particular, the depth T decreases from a center of the crossmember 1 to the respective ends 16 of the crossmember 1. However, in the region where the crash boxes are attached, the varying depth of the profile 4 is kept constant once again.

FIGS. 6a to d show a respective extruded profile 17 in cross section. The extruded profile 17 itself has different wall thicknesses W1, W2, W3, W4. The extruded profile 17 according to FIG. 6a has the four different wall thicknesses W1, W2, W3, W4, so that the operation of flattening and/or widening the profile along the longitudinal extent 9 depicted produces the closing panel 5 according to FIGS. 1 to 5. The extruded width B10 here is smaller than the subsequent length L5 of the closing panel. Following the flattening and/or widening operation, however, the blank for producing the closing panel 5 has a more or less identical length, which corresponds to the length L5 of the closing panel 5. The extrusion direction 10 is oriented in the vertical direction Z of the motor vehicle. The extrusion cross section is located in the X-Y plane.

According to FIG. 6b, a hollow chamber 18, in this case in the form of a double hollow chamber, is formed in a central region on a front side 14 of the closing panel 5 which is to be subsequently produced. When being coupled to the profile 4, this hollow chamber 18 would project into the resulting cavity of the crossmember 1.

FIG. 6c shows a similar variant. Here too, a hollow chamber 18, in the form of a three-chamber hollow profile, is formed on the subsequent front side 14 of the closing panel 5 which is to be produced. A respective double hollow chamber is likewise formed on the rear side 13 of the closing panel 5 which is to be subsequently produced. This double hollow chamber is then arranged in the region of the crash boxes and, in particular, can even replace the crash boxes 3. A constant wall thickness W1 is formed in each of FIGS. 6b and 6c.

According to the variant of FIG. 6d, once again cross-sectionally different wall thicknesses W1, W2, W3, W4 are formed on the closing panel 5. A respective hollow chamber 18 in the form of a double hollow-chamber profile is formed on the subsequent rear side 13 of the closing panel 5 which is to be produced, said double hollow-chamber profile constituting subsequent crash boxes 3 which are formed in one piece with, and in the same material as, the closing panel 5.

A separate concept of the invention can therefore also be the extrusion of a closing panel 5 with corresponding hollow chambers 18 in the form of crash boxes 3. It is possible here, as described above, for the wall thicknesses W1, W2, W3, W4 to vary along the subsequent longitudinal extent 9 of the crossmember 1. However, the wall thicknesses W1, W2, W3, W4 can also be more or less identical.

FIGS. 7a to d show a respective closing panel 5 following the flattening and/or widening operation. The closing panels 5 can correspond to the illustrations from FIGS. 6a to d. The respective change in wall thickness can be formed on the front side 14 or the rear side 11, depending on the crash-related requirements which the crossmember 1 has to meet.

Following the flattening and/or widening operation, the closing panels 5 have a length L5, which corresponds essentially also to the length of the subsequent crossmember 1.

FIGS. 8a to c show respective plan views of three different embodiments of a corresponding closing panel 5. The closing panels 5 have likewise been extruded and are then produced, in the form of a flattened and/or widened sheet, to give individual profile pieces and thus closing panels 5. In all the variants, hollow chambers 18 are formed on the rear side 13 of the closing panel 5, said hollow chambers projecting and therefore functioning, in one piece with, and in the same material as, the closing panel, as crash boxes 3. There is no need for separate coupling to crash boxes 3. In particular where small amounts of packaging or installation space are involved, it is thus possible for a crash box 3 to be simultaneously formed in a corresponding manner. It is likewise the case that the wall thicknesses W1, W2, W3 of the closing panel 5 itself vary once again along the longitudinal extent 9 of the subsequent crossmember 1.

According to the variant of FIG. 8b, extensions in the form of crosspieces 19 project in relation to a subsequent front side 14 of the closing panel 5. These crosspieces then project into a hollow chamber of the profile 4, where the latter is being coupled to the closing panel 5, and are thus arranged in the crossmember 1. The crash boxes 3 according to FIGS. 8a and b are each designed in the form of a two-chamber hollow profile. The crash box 3 according to FIG. 8c is designed in the form of a single-chamber hollow profile. This can be respectively closed, for example by a cover or also by a U-shaped profile piece, for example on its upper side 20 and, not illustrated specifically, on an underside.

It is also possible according to the invention for the variants according to FIGS. 8a to 8c to be combined with a very thin-walled metallic crossmember or with a crossmember which consists of a material, in particular plastic or foam, which is less dense than the material of the closing panel. The crossmember here contributes essentially to protecting the passers-by or pedestrians, whereas the closing panel for the most part performs the structural, crash-specific functions.

FIGS. 9 and 10 show further variants of a respective crossmember 1.

FIGS. 9 and 10 each show a variant of a crossmember arrangement 2 with support provided laterally on the crash box 3. This support is formed in one piece with, and in the same material as, the closing panel 5, in the form of a hollow profile or hollow chamber 18, in particular of a multi-chamber hollow profile. As an alternative, it would also be possible for the support to be designed just in the form of a crosspiece 19.

According to FIG. 9, the support is arranged on the inside of the crash boxes 3, as seen in the transverse direction Y of the motor vehicle. According to FIG. 10, the support is arranged on the outside of the crash boxes 3, as seen in the transverse direction Y of the motor vehicle. The hollow chamber 18 has been, as it were, extruded with the closing panel 5. The extrusion direction 10 of the closing panel 5 is oriented into the plane of the drawing and out of the plane of the drawing, therefore in the vertical direction Z of the motor vehicle.

The support can be supported, as illustrated, on the outer side of the crash box and fastened thereon. However, it is also possible for the support, like the crash box itself, to be supported on a flange plate and to serve as an energy-absorption element and for retaining the crossmember. In the latter case, the support runs essentially parallel to the longitudinal direction X of the motor vehicle.

FIG. 11 shows an alternative variant of a crossmember arrangement 2 according to the invention. In this case, a further hollow chamber 18 is formed so as to project in relation to a rear side 13 of the closing panel 5. An opening 21 is provided in the hollow chamber 18. The opening 21 can serve for accommodating a welding bush for a towing eye (not illustrated specifically). In particular, the welding bush can therefore be shifted for example behind the crossmember 1, so that said bush does not have a negative effect on the crash behavior of the actual crossmember 1 and/or of the crash box 3. The hollow chamber 18 therefore makes it possible for the welding bush to be fastened in the rear wall 22 of the hollow chamber 18 and the rear side 13 of the closing panel 5, said rear wall and rear side being spaced apart from one another, and therefore the welding bush does not buckle for example in the vertical direction Z of the motor vehicle or in the transverse direction Y of the motor vehicle even during use. Selecting an increased wall thickness of the rear wall 22 of the hollow chamber 18 and of the rear side 13 of the closing panel 5 also makes it possible for threaded portions to be integrated, in which case a separate threaded bush can be dispensed with. The same applies for the walls forming the hollow chamber 18, the rear side 13 illustrated here also forming a wall of the hollow chamber 18.

### REFERENCE SKINS

1—Crossmember
2—Crossmember arrangement
3—Crash box
4—Profile
5—Closing panel
6—Wall
7—Limb
8—Flange
9—Longitudinal extent relating to 1
10—Extrusion direction
11—Rear side relating to 6
12—Transition
13—Rear side relating to 5
14—Front side relating to 5
15—Groove
16—End
17—Extruded profile
18—Hollow chamber
19—Crosspiece
20—Upper side
21—Opening
22—Rear wall relating to 18
B10—Extruded width
L1—Length relating to 1
L5—Length relating to 5
X—Longitudinal direction of the motor vehicle
Y—Transverse direction of the motor vehicle
Z—Vertical direction of the motor vehicle
W1—Wall thickness
W2—Wall thickness
W3—Wall thickness
W4—Wall thickness
H—Height relating to 5
T—Depth relating to 4

1. Crossmember for arranging on a motor vehicle, wherein the crossmember is formed in two parts from a profile, which is open on one side, as seen in cross section, and from a closing panel, and the crossmember and the closing panel are coupled to one another, wherein the closing panel is produced in the form of an extruded light-metal component, wherein an extrusion direction is oriented transversely to the longitudinal extent of the crossmember and, as seen in the longitudinal extent of the crossmember, the closing panel has regions of different wall thicknesses and/or has at least one hollow chamber and/or has at least one crosspiece projecting from the closing panel.

2. Crossmember according to claim 1, wherein, as seen in the longitudinal extent of the crossmember, the closing panel extends only part of the way over the crossmember.

3. Crossmember according to claim 1, wherein the closing panel is produced in the form of a tailored extruded blank which is flattened and/or widened.

4. Crossmember according to claim 1, wherein the profile is of top-hat-shaped or C-shaped design in cross section, and/or in that the profile is formed from steel material or light-metal material.

5. Crossmember according to claim 1, wherein the profile and the closing panel are coupled to one another by means of thermal joining, in particular by resistance spot welding.

6. Crossmember according to claim 1, wherein the closing panel has a wall thickness of 2 to 10 mm, wherein a relatively thick and a thinner wall thickness are located within this range.

7. Crossmember according to claim 1, wherein the closing panel has extensions which, following coupling to the profile, project into the latter and/or project from the closing panel on the side located opposite the profile.

8. Crossmember according to claim 1, wherein at least one hollow chamber is simultaneously extruded on the closing panel.

9. Crossmember according to claim 1, wherein crosspieces are formed on the closing panel and these crosspieces, when being coupled to the profile, project into the profile and come into abutment preferably against an inner of a wall of the profile.

10. Crossmember according to claim 1, wherein in each case at least one hollow chamber is formed on the closing panel, in the region where the crossmember is attached to longitudinal members, wherein the hollow chamber projects from the closing panel on the side located opposite the profile, such that the hollow chambers function as crash boxes.

11. Crossmember according to claim 1, wherein, in a central region of the crossmember, the closing panel has a greater wall thickness than the wall thickness of the closing panel toward a respective end region.

12. Crossmember according to claim 1, wherein at least one hollow chamber is formed on the closing panel in a central region of the crossmember, wherein, in the coupled state of the profile and closing panel, the hollow chamber projects into the profile.

13. Crossmember according to claim 1, wherein crash boxes are fastened on the crossmember in a respective end region.

14. Crossmember according to claim 1, wherein the profile and/or the closing panel are/is produced from a metallic material, preferably an aluminum alloy, and have/has in particular a yield strength between 250 MPa and 500 MPa.
